(19) United States
(12) Patent Application Publication
(10) Pub. No.: US 2026/0103242 A1
(43) Pub. Date: Apr. 16, 2026

(54) Trailer Frame Structure and a Recreational Vehicle

(71) Applicant: Global Manufacturing Holdings LLC, Lisle, IL (US)

(72) Inventor: Zhengyi Jiao, Warrenville, IL (US)

(21) Appl. No.: 19/308,682

(22) Filed: Aug. 25, 2025

Related U.S. Application Data
(60) Provisional application No. 63/686,756, filed on Aug. 24, 2024.

(51) Int. Cl. B62D 21/20; B62D 21/12

(52) U.S. Cl. CPC B62D 21/20; B62D 21/12

(57) ABSTRACT

A trailer frame structure includes: a main frame, outriggers and an A-frame. The main frame includes spaced-apart main beams along both sides and cross-members between the main beams. The cross-members are detachably connected to said main beams. The outriggers are detachably mounted on the outer side of the main beams. The top surfaces of the outrigger include a connecting surface, a transitional surface and a supporting surface in turn. The transitional surface is an inclined surface, while the supporting surface is higher than the connecting surface. The vertical face surface of the outrigger is provided with concave reinforcement, wherein the edge of the reinforcement has the same shape as the vertical surface of the outrigger.

This application claims the benefit of U.S. Provisional application Ser. No. 63/686,756, filed Aug. 24, 2024.

### TECHNICAL FIELD

The invention relates to the technical field of recreational vehicle (“RV”) frames, and in particular relates to a trailer frame structure and an RV.

### BACKGROUND TECHNOLOGY

The RV frame structure is the core part of an RV design, which not only relates to the load bearing capacity of the RV, but also directly affects the stability and driving safety. With the growth of RV tourism, consumers are demanding higher levels of comfort, economy and convenience from their RVs. In this context, light weight, modularity, quick assembly and easy transport are becoming the most important considerations in RV frame design.

At present, most domestic RV frames are modified from commercial vehicles, with fewer types and smaller sizes of trailers. Most frame structures are integrally welded from profiles, which has disadvantages such as high material costs, complicated processes, inconvenient packaging and inconvenient long-distance transport. In particular, the RV frame according to existing technology is mainly composed of main beams, cross-members and other components, which are usually joined by welding.

The present inventor has recognized that welding not only increases the manufacturing cost, but also limits the flexibility of the frame and the convenience of transport. In addition, the RV frame is equipped with outriggers that connect the frame and the body, which is mainly used to carry the weight of the body. The side of the outriggers are riveted to the frame of the RV chassis, and the top of the outriggers are connected to the body with drilled and tapped screws. In the conventional outrigger structure, the top surface is usually a whole plane, and the outriggers are in contact with the floor of the body as a whole, which tends to cause some damage to the body on bumpy roads.

### SUMMARY

In view of the shortcomings of the existing technology, an exemplary embodiment of the present invention provides a trailer frame structure.

The exemplary embodiment includes a trailer frame structure comprising: a main frame, outriggers and an A-frame. The main frame comprises spaced-apart main beams along both sides and cross-members between the main beams. The cross-members are detachably connected to said main beams.

The outriggers are detachably mounted on the outer side of the main beams. The top surfaces of the outrigger include a connecting surface, a transitional surface and a supporting surface in turn. The transitional surface is an inclined surface, while the supporting surface is higher than the connecting surface. The vertical face surface of the outrigger is provided with concave reinforcement, wherein the edge of the reinforcement has the same shape as the vertical surface of the outrigger.

The A-frame comprises a left A-frame member and a right A-frame member, the left A-frame member and right A-frame member intersecting at a point at the front end. A middle part of each left and right A-frame member being detachably connected to a cross-member, and the rear end of each left and right A-frame member being detachably connected with the main beams.

Optionally, the cross-members comprise a front cross-member and a rear cross-member. The rear cross-member and the front cross-member have the same structure. The front cross-member and the rear cross-member are situated between the left main beam and the right main beam and form a frame structure with main beams.

Optionally, the cross-members further comprise sheet metal cross-members and truss members. The sheet metal cross-members and truss members are placed longitudinally between the front cross-member and the rear cross-member. The sheet metal cross-member are formed by bending of a steel plate, and the truss member comprise angle steel members and round steel members. The angle steel members enclose a rectangular frame structure, and the round steel members are arranged inclined within the rectangular frame structure.

Optionally, the cross-members further comprise a connecting beam and an anti-collision beam. The connecting beam is located at the front end of the main beams, the connecting beam being provided with first connecting angle plates and first connecting plates. The first connecting angle plates are detachably connected to the main beams, and the first connecting plates are detachably connected to the A-frame. The anti-collision beam is located at the rear end of said main beams, comprising a first square tube and connecting members located at the side of said first square tube. The connecting members are detachably connected to said main beams.

Optionally, the main beam comprises a beam body, an upper support and a lower support. The beam body is in a Z-shape and forms a bend at the end of the beam body. The upper support and lower support both are in an L-shape, the upper support is located under the upper end of the beam body and the lower support is located under the lower end of the beam body.

Optionally, the left and right A-frame members of the A-frame are at a predetermined angle, and a support square tube is provided between the left and right A-frame members. The left A-frame member, the right A-frame member and the support square tube form an A-frame. Battery support members are provided on the rear side of the support square tube.

Optionally, the left and right A-frame members are provided with a coupler at their front ends, and the A-frame is provided with safety chains and mounting rings at its front end.

Optionally, the left and right A-frame members are provided with a second connecting plate in the middle of the top surface and a second connecting angle plate at the rear end of the top surface. The second connecting plate is detachably connected to the connecting beam. The second connecting angle plate is detachably connected to the main beams, and the bottom of the second connecting plate is provided with a support plate.

Optionally, the frame structure further comprises step supports and support leg brackets. The step supports are detachably mounted on the outer side of said main frame, and the support leg brackets are detachably mounted on the bottom side of said main frame. The support leg bracket comprises a base plate, the base plate being provided with a square tube. Guard plates are provided on the end of said square tube.

The embodiment also provides an RV including a body and a trailer frame structure as described above.

The exemplary embodiments include the frame structure of the main frame itself, as well as the main frame and the outriggers and A-frame being connected through the modular detachable design. This can achieve the rapid production and assembly of the frame, and at the same time to facilitate the split packaging, suitable for long-distance transport, to achieve the lightweight, rapid assembly and easy to transport to meet market demand.

By placing the outriggers on the outside of the main beams, the top surfaces of the outrigger include a connecting surface, a transitional surface and a supporting surface to form a streamline or substantially smooth arc, which can cause an effective cushioning and damping effect. Under the effect of the streamline arc, it can effectively reduce the stress concentration when the body is in contact with the chassis frame and can release the stress, which will not cause damage to the body. The streamline arc of the outrigger also improves its overall strength performance, which is 80% higher than that of a whole plane. Further reinforcement is added to ensure that the outriggers have greater strength and lighter weight with the same material and thickness. The shape of the reinforcement matches that of the vertical face surface of the outrigger, which greatly improves the strength, cushioning and damping functions of the entire outrigger.

Advantages of additional aspects of the present exemplary embodiment will be given, in part, as will become apparent from the following description, or as will be learned through the practice of the exemplary embodiment.

### BRIEF DESCRIPTION OF THE DRAWINGS

The accompanying drawings of the specification are used to provide a further understanding of the embodiment of the invention, and the schematic embodiments of the embodiment of the invention and their illustrations are used to explain the embodiment of the invention and do not constitute an undue limitation of the embodiment of the invention.

FIG. 1 is a schematic perspective view of the frame structure provided by the present exemplary embodiment;

FIG. 2 is a schematic perspective view of a first view of an outrigger provided by the present exemplary embodiment;

FIG. 2A is a fragmentary perspective view of an outrigger connected to a main beam;

FIG. 3 is a second schematic perspective view of the outrigger of FIG. 2;

FIG. 4 is a schematic perspective view of a front cross-member provided by the present exemplary embodiment;

FIG. 5 is a side view of the front cross-member of FIG. 4;

FIG. 6 is a schematic perspective view of a sheet metal cross-member provided by the present exemplary embodiment;

FIG. 7 is a schematic perspective view of a truss member provided by the present exemplary embodiment;

FIG. 8 is a schematic perspective view of a connecting beam provided by the present exemplary embodiment;

FIG. 9 is a schematic perspective view of an anti-collision beam provided by the present exemplary embodiment;

FIG. 10 is a sectional view taken generally through plane 10-10 of FIG. 1 viewed in the direction of the arrows;

FIG. 11 is a side view of a main beam installation provided by the present exemplary embodiment;

FIG. 12 is a schematic perspective view of an A-frame provided by the present exemplary embodiment;

FIG. 13 is a schematic perspective view of a step support provided by the present exemplary embodiment;

FIG. 14 is a schematic perspective view of a support leg bracket provided by the present exemplary embodiment;

FIG. 15 is a schematic diagram of a CAE simulation of an outrigger without reinforcement provided by the present exemplary embodiment; and

FIG. 16 is a schematic diagram of a CAE simulation of an outrigger with reinforcement provided by the present exemplary embodiment.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

Distances between components or dimensions of components between have been exaggerated in order to show the position of each part, and the schematic drawings are for illustrative purposes only.

It should be noted that the following detailed descriptions are all illustrative and are intended to provide further clarification of the present exemplary embodiment. Unless otherwise indicated, all technical and scientific terms used in the present exemplary embodiment shall have the meaning commonly understood by those skilled in the art to which the exemplary embodiment belongs.

The exemplary embodiment proposes a trailer frame structure, the size of which can vary from a few meters to a dozen meters, and the RV frame adopts a modular design, which is convenient for transport and can be assembled quickly.

U.S. Provisional application Ser. No. 63/686,756, filed Aug. 24, 2024 is herein incorporated by reference in its entirety.

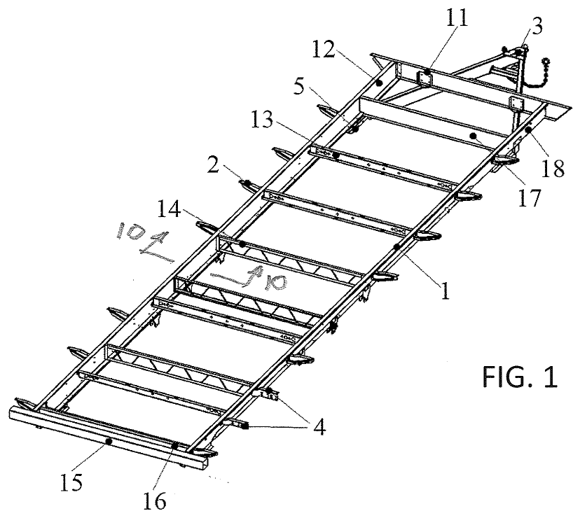

As shown in FIG. 1, an RV frame structure includes a main frame 1, outriggers 2 and an A-frame 3. The main frame 1 includes main beams 12, 18 extending longitudinally on both sides and cross-members 13, 14, 16, 17, wherein the cross-members and the main beams are detachably connected.

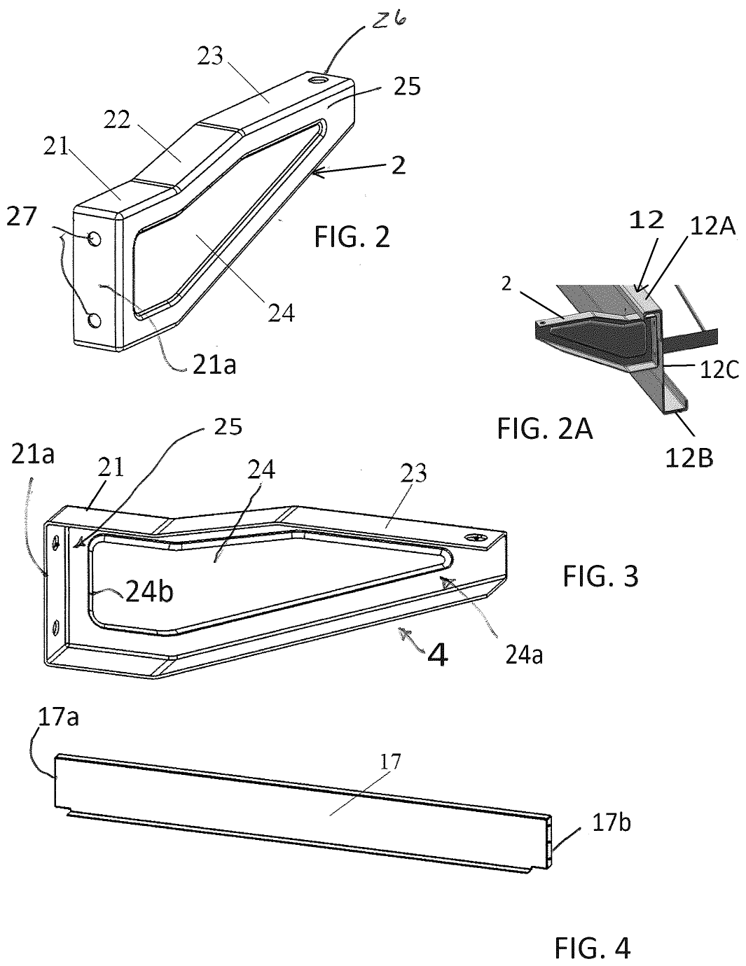

As shown in FIGS. 1, 2, 2A and 3, the outriggers 2 are detachably mounted on the outer side of the main beams 12, 18. The top surfaces of the outrigger 2 includes a connecting or support surface 21, a vertical connecting wall 21a, a transitional surface 22 and a supporting surface 23. The transitional surface 22 is an inclined surface, and the supporting surface 23 is higher than the connecting or support surface 21. A vertical surface 24a of the outrigger 2 is provided with a concave reinforcement 24. A perimeter edge 24b of the reinforcement 24 is of the same shape, but smaller, as the vertical surface 24a of the outrigger 2.

The connecting or support surface 21 fits under an upper flange 12A of the main beams 12, 18 and the vertical connecting surface 21a is bolted through holes 27 to a web 12C of the respective main beams 12, 18. The supporting surface 23 supports an outer portion of the RV body and is bolted thereto through holes 26.

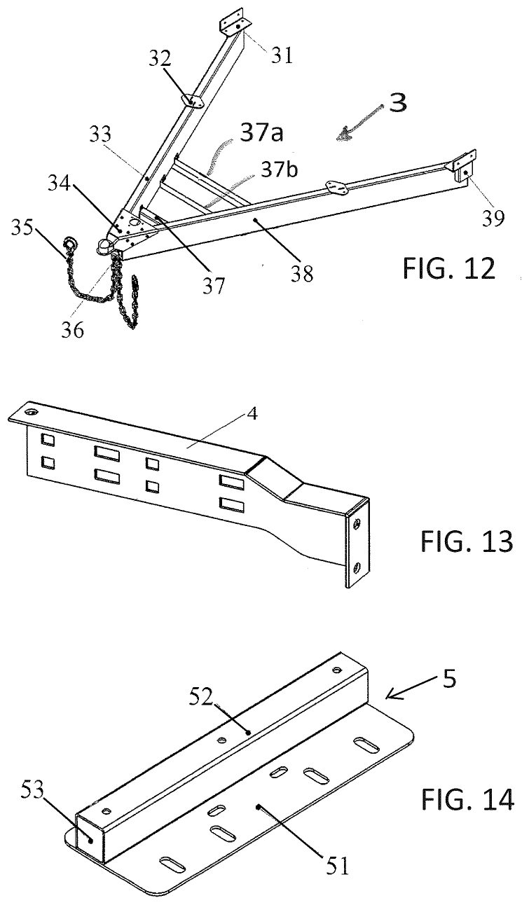

The A-frame 3 comprises a left A-frame member 38 and a right A-frame member 33 as shown in FIG. 12. The left A-frame member 38 and the right A-frame member 33 have front-ends intersecting at a point. Middle locations of the left A-frame member 38 and the right A-frame member 33 are detachably connected to a cross-member 11, and rear ends of the left A-frame member 38 and the right A-frame member 33 are detachably connected to the main beams 12, 18.

The structure of the main frame 1 itself, the outriggers 2 and A-frame 3 are designed according to a modular detachable design, which achieves rapid production and assembly of the frame, and at the same time facilitates split packaging and is suitable for long-distance transportation, thus achieving light-weighting, rapid assembly and convenient transportation to meet market demand.

The outriggers 2 are fixed to the outside of the main beams 12, 18 and are the main structure connecting the frame 1 and the body (not shown). The outriggers 2 are integrally stamped of high strength steel plates and are provided with reinforcement 24, body fixing holes and frame fixing holes and other structures, with adjacent edges welded together as needed, and is connected to the left main beam 12 and the right main beam 18 by Huck bolts. The position of the Huck bolts can be adjusted according to the specific requirements of the RV body.

The top surfaces of the outrigger 2, the connecting or supporting surface 21, the transitional surface 22 and the supporting surface 23 form a streamline or substantially smooth arc, which can cause an effective cushioning and damping effect. Under the effect of the streamline arc, it can effectively reduce the stress concentration when the body is in contact with the chassis frame, and release the stress, to reduce damage to the body. The streamline arc of the outriggers 2 also improves their overall strength performance, which is 80% higher than that of a whole plane.

The addition of the stamped reinforcement 24 ensures that the outriggers 2 are stronger and lighter than others of the same material and thickness. The outriggers 2 are integrally stamped, using a press and die, which improves the strength performance of the outriggers 2, reduces processing costs and also maximizes the load bearing strength of the outriggers. The shape of the reinforcement 24 matches that of the vertical surface of the outrigger 2, which greatly improves the strength, cushioning and damping functions of the entire outrigger 2.

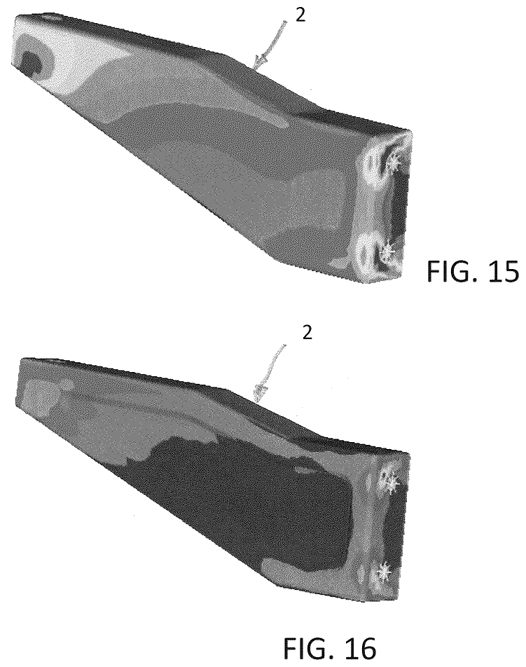

As shown in FIGS. 15 and 16, the strength of the outrigger 2 is significantly improved after the addition of the reinforcement 24 (FIG. 16), compared with the one without reinforcement 24 (FIG. 15), and according to the CAE simulation analysis, the strength of the outrigger 2 is increased by 90% by the addition of the reinforcement 24 compared with that without the reinforcement 24, the state with the reinforcement 24 has smaller stress and better loading capacity compared with the one without the reinforcement 24.

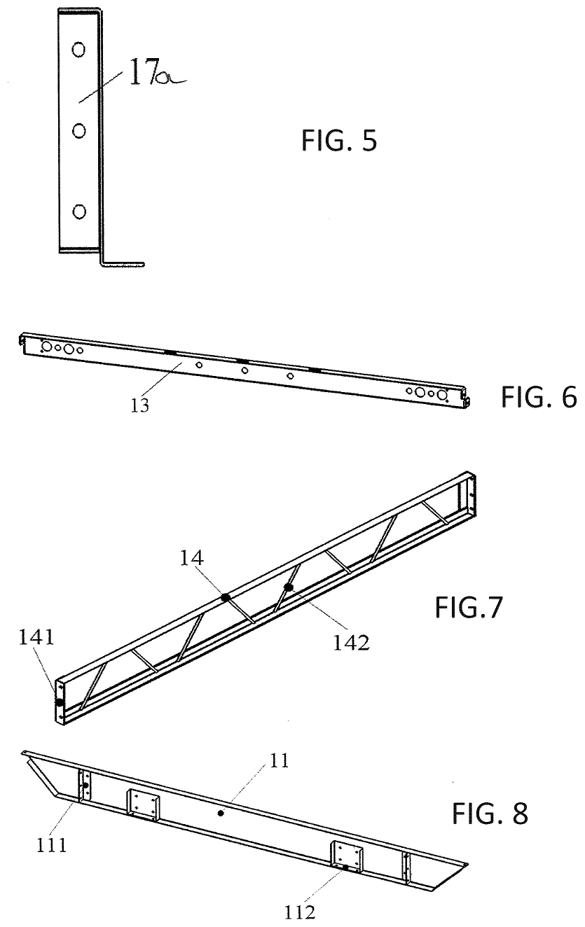

As shown in FIGS. 1, 4 and 5, the cross-members comprise the front cross-member 17 and the rear cross-member 16, the rear cross-member 16 and the front cross-member 17 being of the same structure. The main beams comprise the left main beam 12 and the right main beam 18. The front cross-member 17 and the rear cross-member 16 span between, and are connected to, the left main beam 12 and the right main beam 18 and form a frame structure with the main beams.

The front cross-member 17 and the rear cross-member 16 are both made of high-strength bent steel plate with a Z-shaped cross section, with the adjacent bent edges welded, with holes provided on the bent surface at both ends, and are connected to the left main beam 12 and the right main beam 18 by means of Huck bolts.

As shown in FIGS. 1, 6 and 7, the cross-members further comprise sheet metal cross-members 13 and truss members 14. The sheet metal cross-members 13 and the truss members 14 are placed along the main beams between the front cross-member 17 and the rear cross-member 16. The sheet metal cross-members 13 are formed by bending a steel plate. The truss members 14 comprise angle steel members 141 and round steel members 142, the angle steel members 141 enclose a rectangular frame structure and the round steel members 142 are arranged inclined within the rectangular frame structure. Both the sheet metal cross-members 13 and the truss members 14 are connected to the left main beam 12 and the right main beam 18 by means of Huck bolts, so that the position of the two types of cross-members can be changed according to the actual needs of different RVs.

The sheet metal cross-member 13 can be used for fixing large parts such as a water tank and a waste water tank. The sheet metal cross member can be made of high-strength steel plate and the cross section is Z-shaped. Adjacent bending edges are welded, and the bent surface has holes for connection with the main beams. The main surface of the cross-member is equipped with holes of varied specifications for wiring and other uses. The upper end surface can also be equipped with RV body installation holes.

The truss member 14 can be used to strengthen the rigidity and strength of the whole frame and is welded from angle steel members 141, also known as angle iron or structural steel members, and round steel members 142, to support and strengthen the frame as a whole. The truss member 14 is provided with connecting holes at the left and right end faces for connection to the left main beam 12 and right main beam 18, respectively. The truss member 14 is welded from standard profiles throughout, also known as structural steel members or “angle irons.” Standard profiles can be cut and used without secondary processing. This reduces the processing difficulty, reduces the processing cost, improves the strength and makes the whole cross-member have more solid use performance.

Round steel members 142 welded at angles to the surrounding frame can make the whole truss member 14 more rigid, and the whole frame strength stronger. The truss member 14 is of lightweight construction, compared to the sheet metal bending cross-member, it has lower weight and better plasticity, and the position of the round steel members 142 can be flexibly adjusted according to the requirement of the wire holes and pipelines of the frame, and can be adjusted and positioned with the assembly of other components.

The whole frame is equipped with three truss members 14 in different positions, and reinforced at the axle position because the axle is subject to torsion and shear force, etc. Weight reduction and strength improvement are realized. If water tanks, batteries and other components need to be installed at other positions, the cross-members shall be changed to sheet metal cross-members 13 accordingly, with mounting holes for the installation of water tanks and other components.

The combination of the sheet metal cross-members 13 and the truss members 14 not only ensures the strength requirements of the overall frame, but also satisfies the mounting requirements of the accessories, thus achieving more efficient performance.

As shown in FIGS. 1 and 8, the cross-members further comprise a connecting beam 11 being located at the front end of the main beams 12, 18. The connecting beam 11 is provided with first connecting angle plates 111 and first connecting plates 112, whereas the said first connecting angle plates 111 are detachably connected to the main beams 12, 18, and the first connecting plates 112 being detachably connected to the A-frame 3.

The connecting beam 11 is a beam at the foremost of the frame that plays an important role in connecting the A-frame to the main beams. The body is made of high-strength steel sheet with adjacent bending edges welded to increase the overall rigidity, to which the first connecting plates 112 and the first connecting angle plates 111 are welded, and a reinforcing plate is welded to the inside of the first connecting plate 112. The reinforcing plate is a bent sheet metal structure welded together with the first connecting plate 112, the first connecting plate 112 being a component for connecting the A-frame to the main frame with holes for riveting and being riveted together with the second connecting plates 32 on the A-frame.

The first connecting angle plates 111 are located on both the left and right sides of the connecting beam 11 and is made of angle steel 141, one side of which is welded or riveted to the connecting beam 11 to form an integral whole and the other side of which is connected to the left main beam 12 and the right main beam 18 of the frame respectively by Huck bolts.

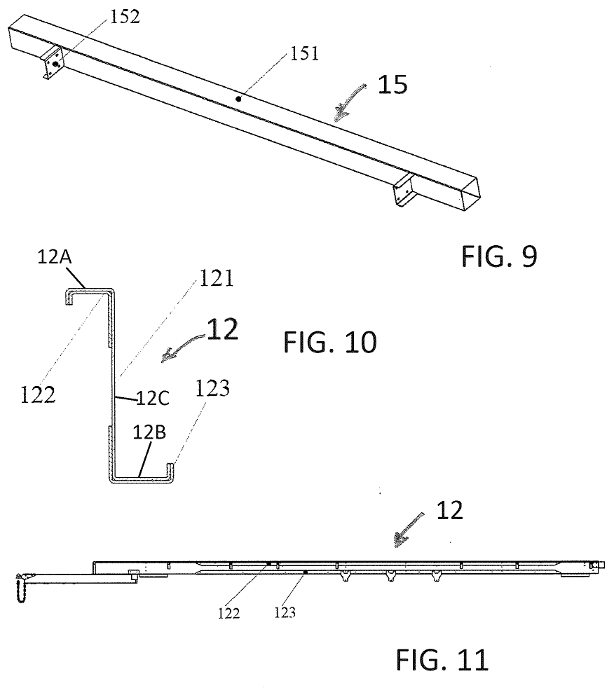

As shown in FIGS. 1 and 9, an anti-collision beam 15 is placed at the rear end of the main beams 12, 18 and comprises a first square tube 151 and connecting members 152 disposed on the side of the first square tube 151, the said connecting members being detachably connected to the main beams 12, 18.

The anti-collision beam 15 absorbs energy in the event of a collision at the rear of the RV to protect the body and passengers. The anti-collision beam 15 is welded from a first square tube 151 and sheet metal connecting members 152 which are connected to the left main beam 12 and the right main beam 18 by Huck bolts.

As shown in FIGS. 10 and 11, the main beams 12, 18 each comprise a beam body 121, an upper support 122 and a lower support 123. The beam body 121 is Z-shaped with an upper flange 12A and a lower flange 12B, extending in opposite directions from a web 12C. The beam body 121 forms a bend at the end of the beam body 121. The upper support 122 and the lower support 123 are both L-shaped, the upper support 122 being disposed under the flange 12A at the upper end of the beam body 121, and said lower support 123 being disposed under flange 12B at the lower end of the beam body 121. The main beams 12, 18 are substantially identical but arranged in mirror image fashion across a longitudinal centerline of the frame 1.

The main beams are the main load-bearing structure of the frame, and the rigidity and strength of the main beams directly affect the overall quality of the RV. In this frame, the left main beam 12 and the right main beam 18 both adopt a Z-shaped sheet metal structure, which is formed in one piece by roller pressing or bending to ensure the overall strength of the main beams, which reduces the assembly process of the main beams and improves the overall assembly efficiency compared with the multi-piece main beams.

In conventional design, to improve the rigidity and strength of the main beams, it is generally achieved by increasing the height and thickness of the main beam cross section, but this also drastically increases the weight, yet the improvement of the overall performance is not obvious. In order to control the weight increase as much as possible, the upper and lower L-shaped supports are creatively adopted as the reinforcement structure of the left main beam 12 and the right main beam 18, which are tightly fitted to the main beams and connected by welding or riveting, and it is found that the overall rigidity of the frame is significantly improved through CAE simulation analysis.

The L-shaped supports can be moved to different positions on the main beam to support different axle weights. The axle weight capacity is 7,000 lbs, 8,800 lbs, 10,200 lbs and so on. By adjusting the L-shaped supports to different positions, it can support different weights of the body, effectively improving the efficiency of the frame and realizing the function of one frame for multiple uses, which not only saves cost but also improves the overall load-bearing strength of the frame. Compared with structures that can't be changed, there are more possibilities and more advantages for cost reduction and performance improvement.

As shown in FIG. 12, the left A-frame member 38 and the right A-frame member 33 of the A-frame 3 are provided at a predetermined angle, and the supporting square tube 37 is provided between the left A-frame member 38 and the right A-frame member 33. The left A-frame member 38, the right A-frame member 33 and the supporting square tube 37 form an A-frame. Battery supporting members 37a, 37b are provided on the rear side of the supporting square tube 37. The left A-frame member 38 and right A-frame member 33 are provided with a coupler 34 at the front end, and safety chains 35 and mounting rings 36 are provided at the front end of the A-frame 3. The left A-frame member 38 and right A-frame member 33 are provided with a second connecting plate 32 in the middle of the top surface, and a second connecting angle plate 31 at the rear end of the top surface, and the second connecting plates 32 are detachably connected to the connecting beam 11, and the second connecting angle plates 31 are detachably connected to the main beams, and a support plate 39 is provided at the bottom of the second connecting plate 32.

The A-frame is located at the foremost of the frame and is a connecting part between the frame and the tow vehicle, and mainly consists of a coupler 34, safety chains 35, a left A-frame member 38, a right A-frame member 33, second connecting plates 32, a supporting square tube 37 and battery support members.

The coupler 34 is located at the front of the A-frame, which is generally made of integral stamped or cast high-strength steel, and its front end has a ball socket structure which can be connected to the A-frame and is equipped with a quick locking mechanism to facilitate assembly and disassembly. The coupler 34 is in the form of a triangle and is riveted or bolted to the left A-frame member 38 and the right A-frame member 33. This forms a one-piece structure by means of Huck bolts at the top and on the left and right sides of the A-frame. The safety chains 35 are a type of safety device to keep the trailer connected to the tow vehicle in movement in case the coupler 34 fails, and the safety chains 35 consist of two chains with safety latches, one end of which are riveted to the left A-frame member 38 and the right A-frame member 33 through the safety chain 35 mounting rings 36 respectively, The other end of the chains are connected to the rear of the tow vehicle through the safety latches to ensure that the trailer is still attached to the tow vehicle even if the coupler 34 fails.

The left A-frame member 38 and the right A-frame member 33 are the main load-bearing structures of the A-frame, consisting of two high strength steel rectangular square tubes with rectangular guard plates 53 welded to both ends of the square tubes, and the left A-frame member 38 and the right A-frame member 33 are riveted together to form an integral whole by means of a coupler 34, a supporting square tube 37 and battery support members 37a, 37b.

The support square tube 37 is made of welded rectangular tubes and sheet metal parts and is riveted to the left A-frame member 38 and the right A-frame member 33 by means of Huck bolts, which contributes to the overall strength of the A-frame. The two battery support members 37a, 37b are bent from sheet metal parts and riveted to the left A-frame member 38 and right A-frame member 33 by Huck bolts to hold the battery and other components that provide power to the RV.

The second connecting plates 32 and the second connecting angle plates 31, both welded to the left A-frame member 38 and the right A-frame member 33, are the portions of the A-frame which are connected to the frame connecting beam 11, the left main beam 12 and the right A-frame member 18, respectively, and which are provided with connecting holes for connecting the A-frame to the main frame by means of Huck bolts to form the frame structure together. In order to strengthen the second connecting angle plate 31, an L-shaped support plate 39 is welded under them.

As shown in FIG. 1, the frame structure further comprises step supports 4 and support leg brackets 5, the step supports 4 being detachably mounted on the outer side of said main frame 1, and the support leg brackets 5 being detachably mounted on the bottom side of said main frame 1.

As shown in FIG. 13, the step supports 4 have the similar structure of outriggers 2, mainly used to fix the RV step assembly, while its upper face is also equipped with a fixing hole connected to the RV body, and the step supports are also made of bent and welded sheet metal.

As shown in FIG. 14, the support leg bracket 5 comprises a base plate 51, said base plate 51 being provided with a second square tube 52, the second square tube 52 being provided with guard plates 53 at both ends. The support leg bracket 5 is a structure for fixing the RV legs and is located at the four corners of the bottom of the frame. When the RV is parked, the four RV legs must be extended to stabilize the RV body and to prevent the RV from skidding on uneven road surfaces or for other reasons. The support leg bracket 5 consists of a second square tube 52 and a steel plate welded together, with fixing holes for connection to the main beam of the frame provided on the square tube and holes for connection to the RV legs provided on the steel plate.

The size of this large trailer frame structure can vary from a few meters to a dozen meters, by using modular design, the overall assembly of the Huck bolt riveting and local welding process to achieve rapid production and assembly of the frame, and at the same time to facilitate the split packaging and long-distance transport, and reduce the cost of transportation. The one-piece frame structure further improves the frame's rigidity and torsional strength, while the optimized structure of the intermediate cross-members effectively reduces the weight of the frame itself, resulting in a lightweight frame and lower production costs.

Based on said frame structure, the embodiments of the exemplary embodiment also provide an RV comprising a body and a frame structure, which not only improves the economic efficiency and market competitiveness of the RV, but also provides a more comfortable, safe and convenient RV travelling experience for the user.

The above description of the specific embodiments of the exemplary embodiment in combination with the accompanying drawings does not constitute a limitation of the scope of protection of the exemplary embodiment. Technicians in the field should understand that, on the basis of the technical solutions of the exemplary embodiment, various modifications or deformations which can be made by technicians in the field without creative work are still within the scope of protection of the exemplary embodiment.

The invention claimed is:

1. A trailer frame structure comprising:
a main frame, outriggers and an A-frame;
said main frame comprises cross-members and main beams on both sides, said cross-members being detachably connected to said main beams;
said outriggers are detachably mounted on the outer side of the main beams, and the top surfaces of the outrigger are a connecting surface, a transitional surface and a supporting surface in turn, said transitional surface being an inclined surface, said supporting surface being higher than the connecting surface, and the vertical surface of said outrigger is provided with a concave reinforcement, and the edge of the reinforcement is of the same shape as the vertical surface of the outrigger;
said A-frame comprises a left A-frame member and a right A-frame member, said left A-frame member and right A-frame member having a front-end intersecting at a point, with their middle portions being detachably connected to the cross-member, and their rear ends being detachably connected to the main beams.

2. The frame structure of a trailer structure as claimed in claim 1, characterized in that said cross-members comprise a front cross-member and a rear cross-member, said rear cross-member and the front cross-member are of the same structure, and said main beams comprise a left main beam and a right main beam, and said front cross-member and the rear cross-member are situated between the left main beam and the right main beam and form a frame structure with the main beams on both sides.

3. The frame structure of a trailer as claimed in claim 2, characterized in that said cross-members further comprise sheet metal cross-members and truss members, said sheet metal cross-members and truss members being placed between a front cross-member and a rear cross-member, said sheet metal cross-member being bent and formed from a steel plate, said truss member comprising angle steel and round steel, said angle steel enclosing a rectangular frame structure, and said round steel being arranged inclined within the rectangular frame structure.

4. The frame structure of a trailer as claimed in claim 2, characterized in that said cross-members further comprise a connecting beam and an anti-collision beam, said connecting beam being located at the front end of the main beams, said connecting beam being provided with first connecting angle plates and first connecting plates, said first connecting angle plates being detachably connected to the main beams, and said first connecting plates being detachably connected to said A-frame; said anti-collision beam being located at the rear end of said main beams, comprising a first square tube and connecting members located on the side of the first square tube, said connecting members being detachably connected to said main beams.

5. A trailer frame structure as claimed in claim 1, characterized in that the main beam comprises a beam body, an upper support and a lower support, said beam body being in a Z-shape and forming a bend at the end of the beam body, said upper support and lower support both being in an L-shape, said upper support being situated at the inner side of the upper end of the beam body, and said lower support being situated at the outer side of the lower end of the beam body.

6. A trailer frame structure as claimed in claim 1, characterized in that said left and right A-frame members are at a predetermined angle, and a support square tube is provided between the left and right A-frame members, with the left and right A-frame members and the support square tube constituting an A-frame; and battery support members are provided on the rear side of said support square tube.

7. A trailer frame structure as claimed in claim 1, characterized in that said left and right A-frame members are provided with coupler at the front end, and said A-frame is provided with safety chains and mounting rings at the front end.

8. A trailer frame structure as claimed in claim 4, characterized in that said left A-frame member and right A-frame member are provided with a second connecting plate in the middle of the top surface, and a second connecting angle plate at the rear end of the top surface, said second connecting plate is detachably connected to said connecting beam, said second connecting angle plate is detachably connected to the main beams and the second connecting plate is provided with a support plate at the bottom.

9. A trailer frame structure as claimed in claim 1, characterized in that the frame structure further comprises step supports and support leg brackets, said step supports being detachably mounted on the outer side of said main frame, said support leg bracket being detachably mounted on the bottom side of said main frame, said support leg bracket comprising a base plate, said base plate being provided with a second square tube, and guard plates being provided at both ends of said second square tube.

10. An RV characterized in that it comprises a body and a trailer frame structure as claimed in claims 1.
